(19) United States
(12) Patent Application Publication
(10) Pub. No.: US 2025/0244474 A1
(43) Pub. Date: Jul. 31, 2025

(54) VEHICULAR RADAR SENSING SYSTEM WITH THREE-DIMENSIONAL ANTENNA CONFIGURATION

(71) Applicant: Magna Electronics Inc., Auburn Hills, MI (US)

(72) Inventors: Christian Schwert, Haßfurt (DE); Dirk Klotzbuecher, Mainstockheim (DE)

(21) Appl. No.: 19/039,999

(22) Filed: Jan. 29, 2025

Related U.S. Application Data
(60) Provisional application No. 63/626,639, filed on Jan. 30, 2024.

(51) Int. Cl. G01S 13/931; G01S 7/03; H01Q 1/32

(52) U.S. Cl. CPC G01S 13/931; G01S 7/03; H01Q 1/3233

(57) ABSTRACT

A vehicular radar sensing system includes a radar sensor disposed at a vehicle and having a printed circuit board, which includes at least one transmitter that transmits radio signals and at least one receiver that receives radio signals. Antenna elements of a plurality of antenna elements (i) receive radio signals transmitted by the transmitter and radiate radio waves representative of the received radio signals or (ii) receive radio waves and pass radio signals representative of the received radio waves to the receiver. A first antenna element of the plurality of antenna elements is disposed at a first surface of the PCB of the radar sensor along a first plane. A second antenna element of the plurality of antenna elements is disposed at a second surface of the PCB of the radar sensor that is along a second plane that is different than the first plane.

### CROSS REFERENCE TO RELATED APPLICATION

The present application claims the filing benefits of U.S. provisional application Ser. No. 63/626,639 filed Jan. 30, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular radar sensing system includes a radar sensor disposed at a vehicle. The radar sensor includes a printed circuit board (PCB). The PCB includes at least one transmitter that transmits radio signals and at least one receiver that receives radio signals. The vehicular radar sensing system includes a plurality of antenna elements. The antenna elements (i) receive radio signals transmitted by the at least one transmitter and radiate radio waves representative of the received radio signals or (ii) receive radio waves and pass radio signals representative of the received radio waves to the at least one receiver. A first antenna element of the plurality of antenna elements is disposed at a first surface of the PCB of the radar sensor. The first surface is along a first plane. A second antenna element of the plurality of antenna elements is disposed at a second surface of the PCB of the radar sensor, and the second surface is along a second plane. The second plane is different than the first plane.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor;

FIG. 2A is a schematic view of an array of antenna elements on a single plane;

FIG. 2B is a schematic view of the array of antenna elements of FIG. 2A and a target object;

FIG. 3A is a schematic view of an array of antenna elements on multiple different planes;

FIG. 3B is a schematic view of the array of antenna elements of FIG. 3A and a target object;

FIG. 4 is a graphical view of two radar sensors of a vision system;

FIG. 5A is a graphical view of an arrangement of antenna elements of an antenna array;

FIGS. 5B and 5C are graphical views of a beam-pattern of the antenna array of FIG. 5A;

FIG. 6A is a graphical view of an arrangement of antenna elements of an antenna array; and

FIGS. 6B and 6C are graphical views of a beam-pattern of the antenna array of FIG. 6A.

### DESCRIPTION OF THE PREFERRED EMBODIMENTS

A vehicle sensing system and/or driver assist system and/or driving assist system and/or object detection system and/or alert system operates to capture sensing data exterior of the vehicle and may process the captured data to detect objects at or near the vehicle and in the predicted path of the vehicle, such as to assist a driver of the vehicle or a control for an autonomous vehicle in maneuvering the vehicle in a forward or rearward direction. The system includes a processor that is operable to receive sensing data from one or more sensors and provide an output, such as an alert or control of a vehicle system.

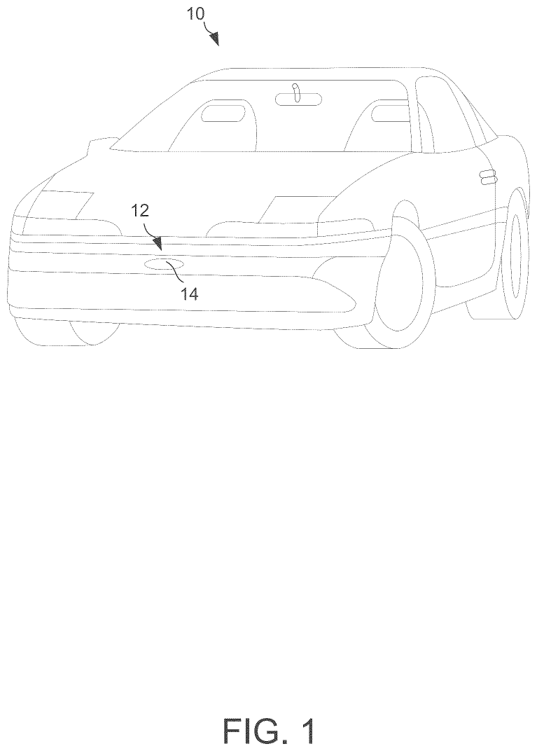

Referring now to the drawings and the illustrative embodiments depicted therein, a vehicle 10 (FIG. 1) includes an driving assistance system or sensing system 12 that includes at least one radar sensor unit, such as a forward facing radar sensor unit 14 (and the system may optionally include multiple exterior facing sensors, such as cameras, radar, or other sensors, such as a rearward facing sensor at the rear of the vehicle, and a sideward/rearward facing sensor at respective sides of the vehicle), which sense regions exterior of the vehicle. The sensing system 12 includes a control or electronic control unit (ECU) that includes a data processor that is operable to process data captured by the radar sensor(s).

The sensing system may also include a radar sensor that includes a plurality of transmitters that transmit radio signals via a plurality of antennas. The radar sensor also includes a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle, with the driving assist system controlling at least one function or feature of the vehicle (such as to provide autonomous driving control of the vehicle) responsive to processing of the data captured by the radar sensors. The data transfer or signal communication from the sensor to the ECU may comprise any suitable data or communication link, such as a vehicle network bus or the like of the equipped vehicle.

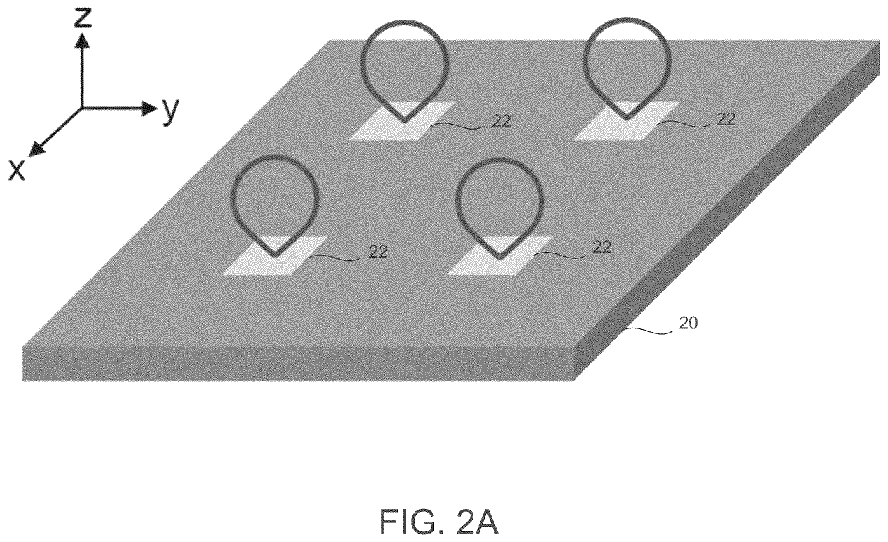

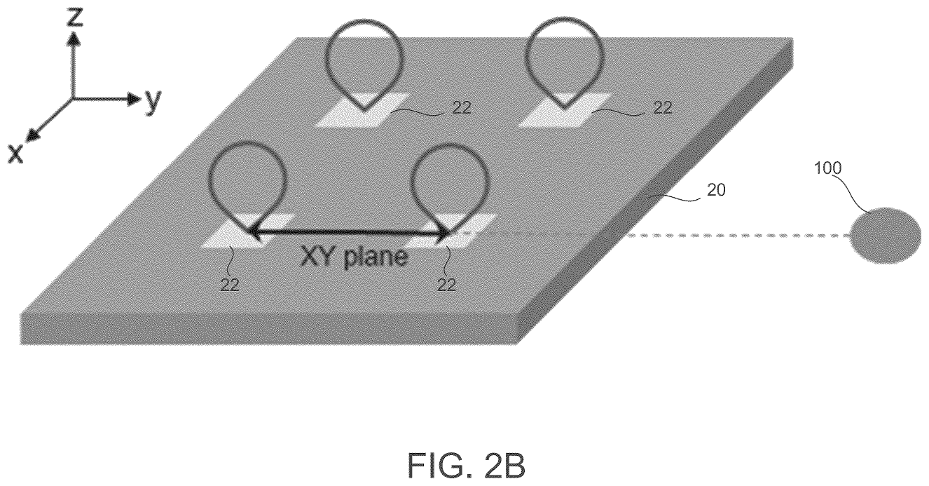

An antenna array (also called an array antenna) is a set of multiple antennas or antenna elements that transmit and/or receive radio waves. For example, the antenna elements receive radio signals (i.e., electrical signals) from a transmitter and radiate radio waves representing the radio signals into the environment and/or the antenna elements receive radio waves from the environment and pass or communicate the radio waves as radio signals to one or more receivers. Each antenna element may be a copper (or other conductive material such as aluminum, silver, gold, brass, or nickel) pad or the like disposed on a surface. Single antenna elements of these arrays are electrically connected so that they work together. That is, a plurality of antenna elements are electrically connected to form an antenna array in which the antenna elements collectively receive and/or transmit radio signals. Such antenna arrays may be used in communication and radar applications. As shown in FIG. 2A, antenna elements 22 are typically arranged in a planar fashion on a printed circuit board 20 (PCB) or other surface (i.e., each antenna element 22 is disposed on the same plane). The displacement of the antenna elements 22 (i.e., location and spacing of the antenna elements 22 with respect to each other) on the planar surface provides advantages in the angle of arrival estimation. In this example, the coordinates for the four antenna elements 22 arranged on the PCB 20 differ in two dimensions in the Cartesian coordinate system (i.e., in the x and the y dimensions). That is, the antenna elements 22 are located on the PCB 20 in the x-y plane. Accordingly, as shown in FIG. 2B, the aperture and angular resolution of the antenna array and each sub-array (i.e., a subset of antenna elements 22 of the antenna array) is zero along the x-y plane (i.e., at z=0). Thus, the antenna array may not detect an object 100 (i.e., a target object) located about the antenna array along the x-y plane (i.e., at any position (x₀, y₀, Z=0)).

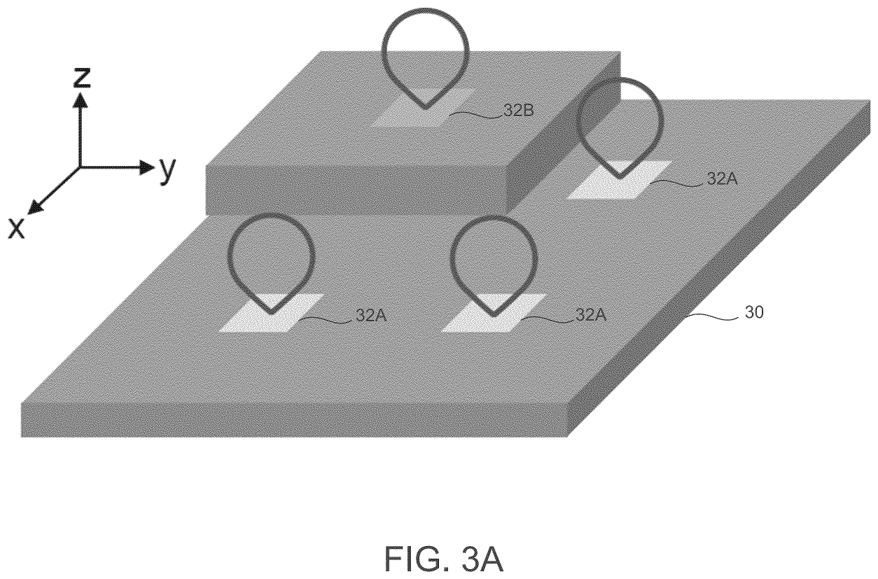

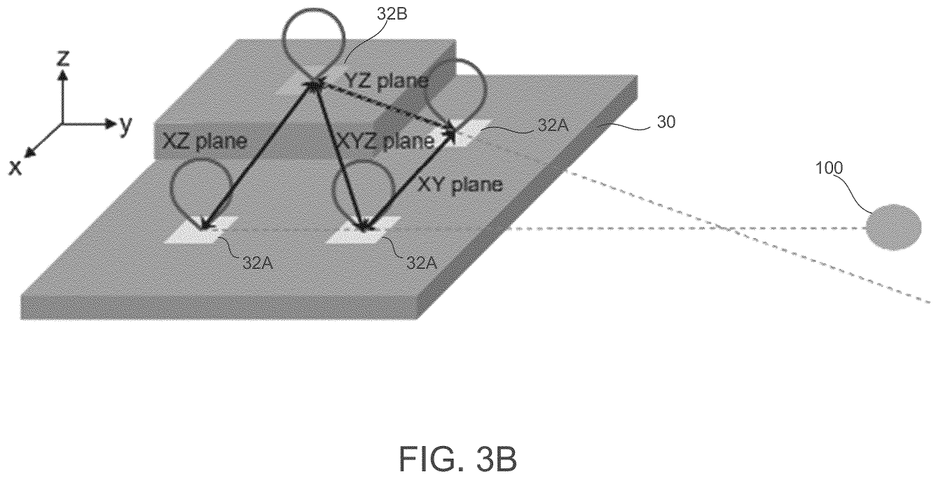

Referring now to FIG. 3A, in some implementations, the vehicular sensing system includes a three-dimensional (3D) arrangement of antenna elements 32A and 32B disposed on a PCB 30 or other surface. That is, at least one antenna element is disposed on a different plane from other antenna elements. In this example, the coordinates of an antenna element 32B differ from three antenna elements 32A in all three dimensions (i.e., in the x dimension, the y dimension, and the z dimension) as opposed to just two dimensions (FIGS. 2A and 2B). More particularly, the three antenna elements 32A have a different z dimension coordinate from the fourth antenna element 32B. The antenna elements 32A may be associated with the transmitter and/or the receiver, and the antenna element(s) 32B may be associated with the transmitter and/or the receiver.

As shown in FIG. 3B, while the aperture and angular resolution of sub-arrays of antenna elements 32A is still zero along the x-y plane, a sub-array of antenna elements 32A and 32B located along the y-z plane has an aperture and angular resolution greater than zero along the x-y plane. Accordingly, the sub-array of antenna elements 32A and 32B have a non-zero aperture and a non-zero angular resolution at the location of the object 100. Thus, the antenna array may detect the object 100, even when the object 100 is located about the antenna array at a location along the x-y plane (i.e., at a position (x₀, y₀, z=0)). With planes formed by various sub-arrays of the antenna elements 32A, 32B, the antenna array has a non-zero aperture and a non-zero angular resolution at all locations about the antenna array. That is, by combining the various planes formed by the various sub-arrays of antenna elements 32A, 32B, there is no location about the antenna array at which the aperture and the angular resolution of the antenna array are zero.

The antenna elements 32A, 32B may be arranged or disposed in a grid pattern, as shown in FIGS. 3A and 3B, such that each antenna element 32A, 32B has a unique x and y position on the PCB 30. For example, a first antenna element 32A may have a position of (x₁, y₁, z₂), a second antenna element 32A may have a position of (x₂, y₁, z₂), a third antenna element 32A may have a position of (x₁, y₂, z₂), and a fourth antenna element 32B may have a position of (x₂, y₂, z₂). Alternatively, the antenna elements 32A, 32B may be arranged or disposed in a linear pattern. For example, a first antenna element 32A may have a position of (x₁, y₁, z₂), a second antenna element 32A may have a position of (x₂, y₁, z₂), a third antenna element 32A may have a position of (x₃, y₁, z₂), and a fourth antenna element 32B may have a position of (x₄, y₁, z₂).

The angular resolution of a radar is defined by the aperture of the used planar antenna array. The more the single antenna elements are distributed in such an array (e.g., the more antenna elements and/or the greater distance between antenna elements of the array), the larger the aperture and the better the angular resolution. That is, the “larger” the antenna, the larger the aperture. By positioning or locating the antenna elements on different planar surfaces (i.e., surfaces in different planes along the z-axis), such as when at least one antenna element differs in the z dimension from the other antenna elements, range estimation is improved in both accuracy and resolution by increasing the aperture without needing to significantly increase the planar size of the antenna. That is, by including antenna elements with different z dimensions, the aperture of the radar can be increased without requiring significant increases in the x and y dimensions of the antenna.

The baselines of the aperture of the antenna array are not the same for all antenna combinations and therefore the aperture minima are not at the same angle. For planar elements, this may always be at +/−90 degrees. For antennas with different z positions, this may be at a different angle. This enables a wider field of view because the aperture minima may be designed to create an advantageous overall pattern of the antenna array.

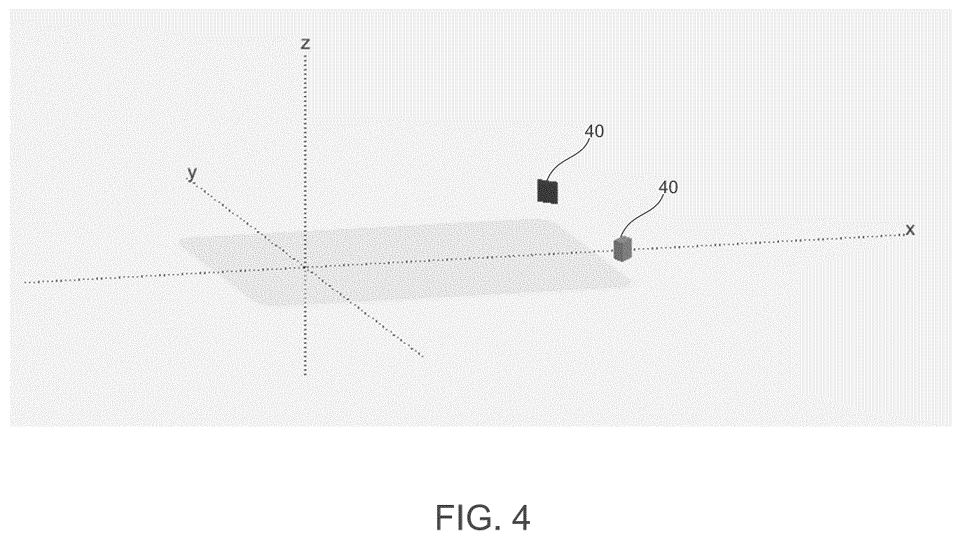

FIG. 4 illustrates a pair of radar sensors 40 including antenna arrays. The radar sensors 40 are positioned in accordance with a common position of radar sensors of a radar system of a vehicle, with one sensor in each corner of a front bumper of the vehicle. In this example, each radar sensor 40 may be oriented at an angle (i.e., an installation angle) of 62.5 degrees with respect to a longitudinal axis of the vehicle (here, the x-axis). That is, each radar sensor 40 may be oriented at an angle such that the radar sensor 40 has a field of sensing facing outwardly from the longitudinal axis of the vehicle. In other examples, the installation angle may be 15 degrees, 30 degrees, 45 degrees, 60 degrees, 75 degrees, 90 degrees, etc. The effective antenna aperture (α) of the vision system follows a function of bearing (α′), where α′=sin (Θ)×α. In examples where the antenna elements of the radar sensors 40 are arranged in a planar fashion, the angular resolution of the vision system is reduced in the direction of travel of the vehicle. By varying the antenna elements of the radar sensors 40 to form a multi-plane antenna array, the angular resolution of the vision system may be optimized for the given installation angle of the radar sensors 40. That is, by varying the antenna elements of the antenna arrays in not only the y-dimension and the z-dimension, but also in the x-dimension, the angular resolution of the vision system may be optimized for the given installation angle of the radar sensors 40. Accordingly, the vision system will have a smaller drop in resolution at larger installation angles (i.e., when the radar sensors 40 are angled further away from the longitudinal axis of the vehicle).

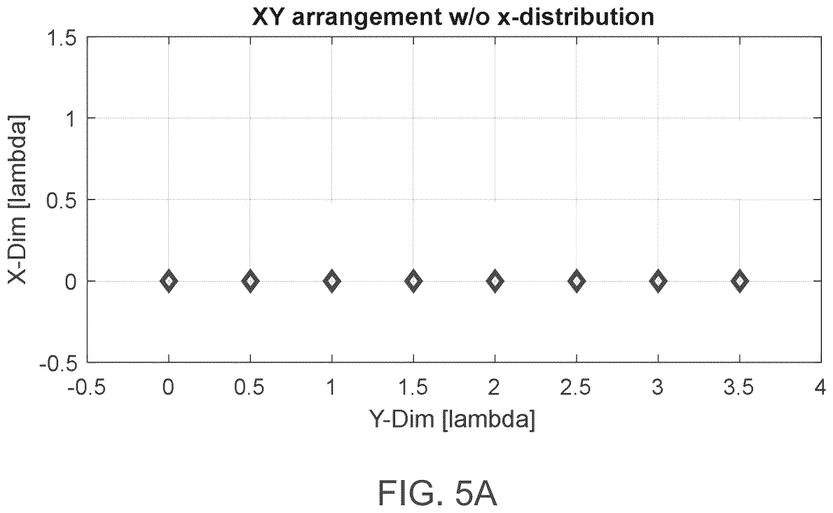

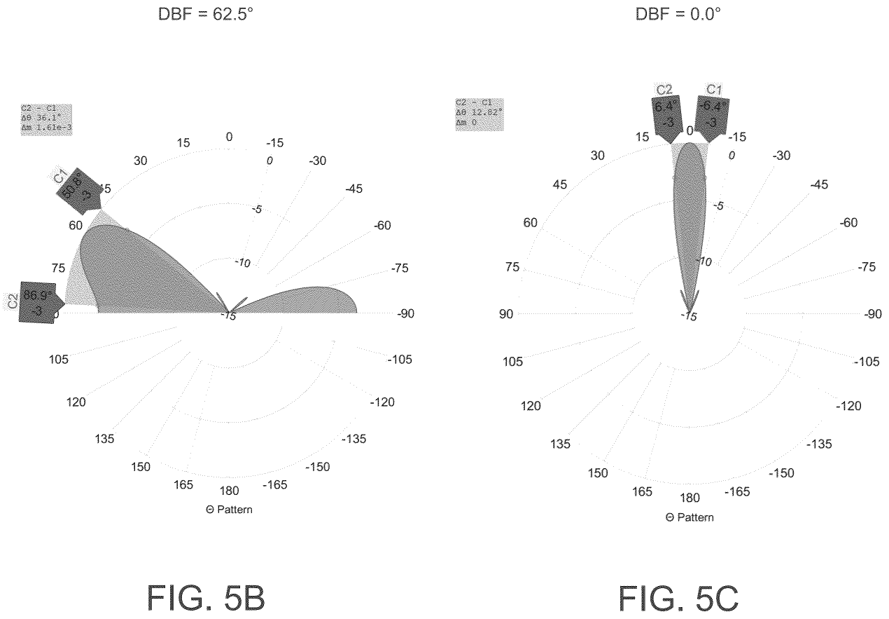

FIGS. 5A-5C illustrate the antenna design and sensing characteristics of each radar sensor 40 of the vision system of FIG. 4, where the antenna elements of each radar sensor 40 are distributed along a single plane. Each radar sensor 40 includes an antenna array of 8 antenna elements. As shown in FIG. 5A, the antenna elements are uniformly arranged (i.e., homogeneously arranged) with a spacing of 0.5λ. The antenna array has an aperture in the z-dimension of 0.0λ, an aperture in the y-dimension of 3.5λ, and an aperture in the x-dimension of 0.0λ. When the antenna array is configured to create a main lobe of 62.5 degrees using digital beamforming (i.e., the antenna array has a DBF of 62.5 degrees), the 3-decibel beamwidth (3-dB BW) is 36.1 degrees (FIG. 5B). Where the antenna array is configured to have a DBF of 0.0 degrees, the 3 dB BW is 12.8 degrees (FIG. 5C).

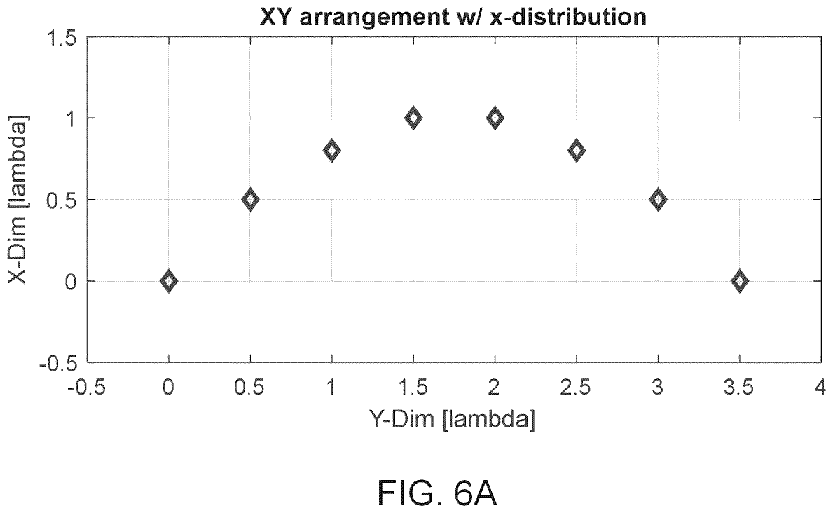

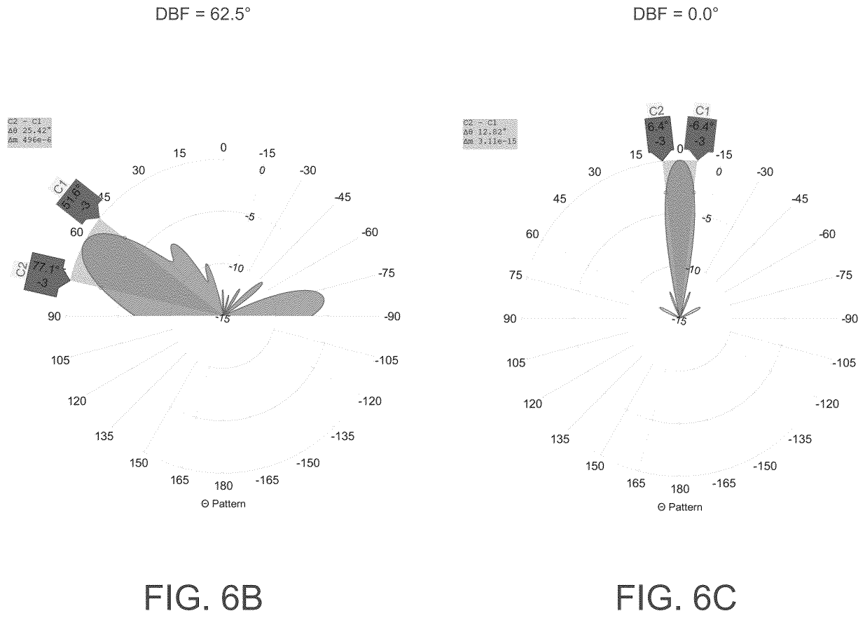

FIG. 6A-6C illustrates the antenna design and sensing characteristics of each radar sensor 40 of the vision system of FIG. 4, where the antenna elements of each radar sensor 40 are distributed in a multi-plane arrangement. Each radar sensor 40 includes an antenna array of 8 antenna elements. As shown in FIG. 6A, the antenna elements are uniformly arranged with a spacing of 0.5λ. The antenna array has an aperture in the z-dimension is 0.0λ, an aperture in the y-dimension is 3.5λ, and an aperture in the x-dimension is 1.0λ. When the antenna array is configured to have a DBF of 62.5 degrees, the 3-dB BW is 25.4 degrees (FIG. 6B). When the antenna array is configured to have a DBF of 0.0 degrees, the 3-dB BW is 12.8 degrees (FIG. 6C). Accordingly, the multi-plane antenna array has a narrower 3-dB BW, and therefore better resolution, than the single-plane antenna array at large DBF angles while maintaining the same resolution at a DBF of 0.0 degrees. Thus, arranging the antenna elements on multiple planes increases the breadth of the aperture and the resolution of the antenna, resulting in a larger and/or more accurate field of sensing for the vehicular sensing system.

Thus, the radar sensor includes a “multi-level” or multi-planar surface for antenna elements such that at least one antenna element (associated with the transmitter and/or the receiver) has a different z coordinate in the Cartesian coordinate system relative to the other antenna elements (associated with the transmitter and/or the receiver). For example, when the radar sensor is disposed at the front of the vehicle, one or more antenna elements may be disposed on a first plane at a first “height” from the front of the vehicle (e.g., the bumper) and one or more other antenna elements may be disposed on a second plane at a second height from the front of the vehicle that is different from the first height. The radar sensor may include additional planes (e.g., a third plane, a fourth plane, etc.) based on the design requirements of the radar sensor. In this example, the height represents a distance along the longitudinal axis of the vehicle between the front of the vehicle and the plane. In some examples of radar sensors including three or more planes, the planes may increase sequentially in longitudinal axis to form gradients (i.e., the planes increase in height in a stepped fashion). In other examples, the three or more planes may form concave-shaped or convex-shaped antenna arrays. Accordingly, the field of sensing of the radar sensor may be shaped by the varying distances of the planes. The surface may be a surface of a PCB with a riser, waveguide, or any other structure or substrate to provide a different z dimension plane. The radar sensor may include any number of antenna elements at any number of differing heights and in any number of orientations. For example, the radar sensor may include antenna elements disposed at two, three, or more different planes (each with a different z dimension). Each plane may have any number of antenna elements in any orientation (e.g., grids). The antenna elements may be connected via traces (e.g., copper traces), vias, or any other known connection techniques.

A vehicular radar sensing system includes a radar sensor disposed at a vehicle, where the radar sensor includes a PCB that includes at least one transmitter that transmits radio signals and at least one receiver that receives radio signals. The radar sensor includes a plurality of antenna elements, where the antenna elements (i) receive radio signals transmitted by the at least one transmitter and radiate radio waves representative of the received radio signals or (ii) receive radio waves and pass radio signals representative of the received radio waves to the at least one receiver. A first antenna element of the plurality of antenna elements is disposed at a first surface of the PCB of the radar sensor, and the first surface is along a first plane. A second antenna element of the plurality of antenna elements is disposed at a second surface of the PCB of the radar sensor, and the second surface is along a second plane. The second plane is different than the first plane.

The second plane may be parallel to the first plane. In some examples, the first plane may be perpendicular to a longitudinal axis of the vehicle. In other examples, the first plane may be oriented at an angle of less than 90 degrees with respect to the longitudinal axis of the vehicle. In further examples, the first antenna element is disposed on a first portion of the PCB, and the second antenna element is disposed on a second portion of the PCB. In still further examples, the first antenna element is part of a first array of antenna elements disposed on the first surface of the radar sensor, and the second antenna element is part of a second array of antenna elements disposed on the second surface of the radar sensor.

In some examples, a third antenna element of the plurality of antenna elements is disposed on a third surface of the radar sensor, where the third surface is disposed along a third plane. The third plane is different than the first plane and the second plane. The third plane may be parallel to the second plane, and the second plane may be parallel to the first plane.

In some examples, the second surface includes at least one selected from the group consisting of (i) a riser, (ii) a waveguide, and (iii) a substrate. In further examples, the plurality of antenna elements is disposed in a grid pattern. In other examples, the plurality of antenna elements is disposed in a linear pattern. In some examples the first antenna element and the second antenna element receive radio signals from the same transmitter. In other examples, the first antenna element and the second antenna element pass radio signals to the same receiver. In further examples, the radar sensor may be a plurality of radar sensors.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior or interior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular radar sensing system, the vehicular radar sensing system comprising:
a radar sensor disposed at a vehicle;
wherein the radar sensor comprises a printed circuit board (PCB);
wherein the PCB comprises at least one transmitter that transmits radio signals and at least one receiver that receives radio signals;
a plurality of antenna elements, wherein the antenna elements (i) receive radio signals transmitted by the at least one transmitter and radiate radio waves representative of the received radio signals or (ii) receive radio waves and pass radio signals representative of the received radio waves to the at least one receiver;
wherein a first antenna element of the plurality of antenna elements is disposed at a first surface of the PCB of the radar sensor, and wherein the first surface is along a first plane; and
wherein a second antenna element of the plurality of antenna elements is disposed at a second surface of the PCB of the radar sensor, and wherein the second surface is disposed along a second plane, and wherein the second plane is different than the first plane.

2. The vehicular radar sensing system of claim 1, wherein the second plane is parallel to the first plane.

3. The vehicular radar sensing system of claim 2, wherein the first plane is perpendicular to a longitudinal axis of the vehicle.

4. The vehicular radar sensing system of claim 2, wherein the first plane is oriented at an angle of less than ninety (90) degrees with respect to a longitudinal axis of the vehicle.

5. The vehicular radar sensing system of claim 1, wherein the first antenna element is disposed on a first portion of the PCB, and wherein the second antenna element is disposed on a second portion of the PCB.

6. The vehicular radar sensing system of claim 1, wherein the first antenna element is part of a first array of antenna elements disposed on the first surface of the PCB, and wherein the second antenna element is part of a second array of antenna elements disposed on the second surface of the PCB.

7. The vehicular radar sensing system of claim 1, wherein a third antenna element of the plurality of antenna elements is disposed on a third surface of the PCB, and wherein the third surface is disposed along a third plane, and wherein the third plane is different than the first plane and the second plane.

8. The vehicular radar sensing system of claim 7, wherein the third plane is parallel to the second plane, and wherein the second plane is parallel to the first plane.

9. The vehicular radar sensing system of claim 1, wherein the second surface comprises at least one selected from the group consisting of (i) a riser and (ii) a waveguide.

10. The vehicular radar sensing system of claim 1, wherein the plurality of antenna elements is disposed in a grid pattern.

11. The vehicular radar sensing system of claim 1, wherein the plurality of antenna elements is disposed in a linear pattern.

12. The vehicular radar sensing system of claim 1, wherein the first antenna element and the second antenna element receive radio signals from the same transmitter.

13. The vehicular radar sensing system of claim 1, wherein the first antenna element and the second antenna element pass radio signals to the same receiver.

14. The vehicular radar sensing system of claim 1, further comprising a plurality of radar sensors.

15. A vehicular radar sensing system, the vehicular radar sensing system comprising:
a radar sensor disposed at a vehicle;
wherein the radar sensor comprises a printed circuit board (PCB);
wherein the PCB comprises at least one transmitter that transmits radio signals and at least one receiver that receives radio signals;
a plurality of antenna elements, wherein the antenna elements (i) receive radio signals transmitted by the at least one transmitter and radiate radio waves representative of the received radio signals or (ii) receive radio waves and pass radio signals representative of the received radio waves to the at least one receiver;
wherein a first antenna element of the plurality of antenna elements is disposed at a first surface of the PCB of the radar sensor, and wherein the first surface is along a first plane, and wherein the first antenna element is part of a first array of antenna elements disposed on the first surface of the PCB; and
wherein a second antenna element of the plurality of antenna elements is disposed at a second surface of the PCB of the radar sensor, and wherein the second surface is along a second plane, and wherein the second plane is different than the first plane, and wherein the second antenna element is part of a second array of antenna elements disposed on the second surface of the PCB, and wherein the second surface comprises at least one selected from the group consisting of (i) a riser and (ii) a waveguide.

16. The vehicular radar sensing system of claim 15, wherein the second plane is parallel to the first plane.

17. The vehicular radar sensing system of claim 15, wherein the second plane is parallel to the first plane, and wherein the first plane is oriented at an angle of less than ninety (90) degrees with respect to a longitudinal axis of the vehicle.

18. The vehicular radar sensing system of claim 15, wherein a third antenna element of the plurality of antenna elements is disposed on a third surface of the PCB, and wherein the third surface is disposed along a third plane, and wherein the third plane is different than the first plane and the second plane.

19. A vehicular radar sensing system, the vehicular radar sensing system comprising:
a radar sensor disposed at a vehicle;
wherein the radar sensor comprises a printed circuit board (PCB);
wherein the PCB comprises at least one transmitter that transmits radio signals and at least one receiver that receives radio signals;
a plurality of antenna elements, wherein the antenna elements (i) receive radio signals transmitted by the at least one transmitter and radiate radio waves representative of the received radio signals or (ii) receive radio waves and pass radio signals representative of the received radio waves to the at least one receiver;
wherein a first antenna element of the plurality of antenna elements is disposed at a first surface of the PCB of the radar sensor, and wherein the first surface is along a first plane;
wherein a second antenna element of the plurality of antenna elements is disposed at a second surface of the PCB of the radar sensor, and wherein the second surface is disposed along a second plane, and wherein the second plane is different than the first plane; and
wherein the first antenna element and the second antenna element receive radio signals from the same transmitter, and wherein the first antenna element and the second antenna element pass radio signals to the same receiver.

20. The vehicular radar sensing system of claim 19, wherein the first antenna element is disposed on a first portion of the PCB, and wherein the second antenna element is disposed on a second portion of the PCB.

21. The vehicular radar sensing system of claim 19, wherein a third antenna element of the plurality of antenna elements is disposed on a third surface of the PCB, and wherein the third surface is disposed along a third plane, and wherein the third plane is different than the first plane and the second plane.

22. The vehicular radar sensing system of claim 19, wherein the plurality of antenna elements is disposed in a grid pattern.
